(19) United States
(12) Patent Application Publication
(10) Pub. No.: US 2023/0028378 A1
(43) Pub. Date: Jan. 26, 2023

(54) SYSTEM AND DEVICE FOR AIR PURIFICATION

(71) Applicant: ZERO2.5 BIOTECH PTE. LTD., Singapore (SG)

(72) Inventors: Swain STEPHEN, Singapore (SG); Hean Chuan FONG, Singapore (SG)

(73) Assignee: ZERO2.5 BIOTECH PTE. LTD., Singapore (SG)

(21) Appl. No.: 17/788,766

(22) PCT Filed: Dec. 22, 2020
(86) PCT No.: PCT/SG2020/050772

§ 371 Date: Jun. 24, 2022

(30) Foreign Application Priority Data
Dec. 26, 2019 (SG) 10201913413Y

(51) Int. Cl. A01G 7/04; H01T 23/00; B03C 3/38; B03C 3/68

(52) U.S. Cl. CPC A01G 7/04; H01T 23/00; B03C 3/38; B03C 3/68; B03C 2201/24

(57) ABSTRACT

The present invention relates to a system for air purification. The system comprises at least a first plant and a second plant, and a voltage pulse device connectable to a power source for generating and transmitting a voltage pulse to the first plant, wherein the second plant is connected to the first plant using at least one voltage pulse transmission unit, and the first plant and the second plant are arranged to form one or more contact areas at a leaf portion. The system may also comprise a plurality of plants mounted on a support structure in accordance with some embodiments. The present invention also relates to a voltage pulse device for use with the system for air purification.

### FIELD

The present disclosure relates to an air purification system. The present disclosure also relates to a voltage pulse device for use with the system for air purification.

### BACKGROUND ART

The following discussion of the background to the disclosure is intended to facilitate an understanding of the present disclosure only. It should be appreciated that the discussion is not an acknowledgement or admission that any of the material referred to was published, known or part of the common general knowledge of the person skilled in the art in any jurisdiction as at the priority date of the disclosure.

Air quality in major cities across the globe is taking a hit due to urbanization and industrialization. Among others, airborne particles such as PM2.5 (respirable particulate matter of 2.5 μm or less) are major source of air pollutants. It is shown that PM2.5 is associated with various health implications including breathing and respiratory problems. Further, nanoparticles inhaled and accumulated within systemic circulation are also shown to be one of the possible causes of cardiovascular diseases.

Existing air purification technologies include using air filters (such as a High-efficiency particulate air or HEPA filter) to trap airborne particles by size exclusion and using other filtration/adsorption materials to physically capture the particulate matter and hazardous chemicals in the air. These air purification technologies are plagued with problems including frequent filter changes, and low efficiency. Also, the upfront deployment and operation cost of adopting these air purification technologies for outdoor and large-scale applications can be significant.

In recent years, plant-based systems which use power pulses to stimulate plants for emitting negative air ions (NAIs) have been developed. It is shown that the negative air ions may effectively accelerate the precipitation of particulate matter in the surrounding environment and may bring about other health benefits to human beings at the same time. However, the air cleaning efficiency and coverage area of existing plant based NAIs generating systems are limited, making its implementation for large-scale air purification difficult. Furthermore, safety issues may arise as a result of the relatively unstable load condition, and due to other uncontrollable and unpredictable environmental factors.

The present disclosure contemplates that it would be desirous to provide a system and device for air purification to at least alleviate or mitigate the afore-mentioned problems.

### SUMMARY

In accordance to one aspect of the present disclosure, there is provided a system for air purification, comprising at least a first plant and a second plant, and a voltage pulse device connectable to a power source for generating and transmitting a voltage pulse to the first plant, wherein the second plant is connected to the first plant using at least one voltage pulse transmission unit, and the first plant and the second plant are arranged to form one or more contact areas at a leaf portion.

In some embodiments, the at least one voltage pulse transmission unit is configured to transmit the voltage pulse from a stem portion or a root portion of the first plant to a stem portion or a root portion of the second plant.

In some embodiments, the voltage pulse device comprises a voltage pulse generating circuit configured to receive an input voltage derived from the power source, and to generate the voltage pulse of a desired voltage level; an output monitoring circuit connected to the output side of the voltage pulse generating circuit, the output monitoring circuit operable to detect at least one of the following operational parameters: an output voltage level, an output voltage ramping rate, an output current level; and an electronic controller arranged in data communication with the voltage pulse generating circuit and the output monitoring circuit, the electronic controller operable to receive at least one of the operational parameters from the output monitoring circuit and to control operation of the voltage pulse generating circuit based on a per-determined rule.

In some embodiments, the output monitoring circuit comprises a voltage sensing module connected to a voltage output line of the voltage pulse generating circuit, and a current sensing module connected to a ground reference line of the voltage pulse generating circuit.

In some embodiments, the voltage sensing module connected to the voltage output line comprises a voltage divider, wherein the output voltage is divided by a pre-determined number for measurement.

In some embodiments, the electronic controller is operable to selectively deactivate the voltage generating circuit based on the detected voltage level.

In some embodiments, after the voltage pulse generating circuit is activated and in a transient state before the output voltage reaches the desired voltage level, the electronic controller is operable to selectively deactivate the voltage pulse generating circuit based on the detected output voltage ramping rate.

In some embodiments, in a steady state where the desired voltage level is reached, the electronic controller is operable to selectively deactivate the voltage generating circuit based on the detected output current level.

In some embodiments, the voltage pulse device is connectable to a stimulating probe for transmitting the voltage pulse to a root portion of the first plant.

In some embodiments, the system further comprises a power supply device for deriving a pre-determined input voltage for the voltage pulse device.

In some embodiments, the system further comprises a proximity sensing module configured to detect an intruding object.

In some embodiments, the system further comprises a support structure for holding the first plant and the second plant in a desired position with respect to each other.

In some embodiments, the system further comprises a ventilation mechanism for facilitating air flow in a pre-determined direction (and/or at a pre-determined rate).

In accordance to another aspect of the present disclosure, there is provided a system for air purification, comprising a plurality of plants mounted on a support structure, and at least one voltage pulse device connectable to a power source for generating and transmitting a voltage pulse to the plurality of plants, wherein each one of the plurality of plants is connected with another plant using at least one voltage pulse transmission unit and/or is configured to form one or more contact areas with another plant at a leaf portion thereof.

In some embodiments, the voltage pulse transmission unit is configured to transmit the voltage pulse from a stem portion or a root portion of one plant to a stem portion or a root portion of another plant.

In some embodiments, the voltage pulse device comprises a voltage pulse generating circuit configured to receive an input voltage from the power source, and to generate the voltage pulse of a desired voltage level and a desired pulse frequency; an output monitoring circuit connected to the output side of the voltage pulse generating circuit, the output monitoring circuit operable to detect at least one of the following operational parameters: an output voltage level, an output voltage ramping rate, an output current level; and an electronic controller arranged in data communication with the voltage pulse generating circuit and the output monitoring circuit, the electronic controller operable to receive at least one of the operational parameters from the output monitoring circuit and to control operation of the voltage pulse generating circuit based on a per-determined rule.

In some embodiments, the output monitoring circuit comprises a voltage sensing module connected to a voltage output line of the voltage pulse generating circuit, and a current sensing module connected to a ground reference line of the voltage pulse generating circuit.

In some embodiments, the voltage sensing module comprises a voltage divider, wherein the output voltage level is divided by a pre-determined number for measurement.

In some embodiments, the electronic controller is operable to selectively activate the voltage generating circuit based on the detected voltage level.

In some embodiments, after the voltage pulse generating circuit is activated and in a transient state before the output voltage reaches the desired voltage level, the electronic controller is operable to selectively deactivate the voltage pulse generating circuit based on the detected output voltage ramping rate.

In some embodiments, in a steady state where the desired voltage level is reached, the electronic controller is operable to selectively deactivate the voltage generating circuit based on the detected output current level.

In some embodiments, the voltage pulse device comprises a stimulating probe for conducting the voltage pulse to a root portion of at least one of the plurality of plants.

In some embodiments, the system further comprises a proximity sensing module configured to detect an intruding object.

In some embodiments, the system further comprises a power supply device for deriving a pre-determined input voltage for the voltage pulse device.

In some embodiments, the support structure comprises one or more planar surfaces, and/or one or more curved surfaces.

In some embodiments, the system further comprises a watering mechanism configured to direct water from a water source to the plurality of plants, and to direct excess water from the plurality of plants to a water collector and/or to another system.

In some embodiments, the system further comprises a ventilation mechanism for facilitating air flow in a pre-determined direction.

In accordance to a further aspect of the invention, there is provided a voltage pulse device for use with the system, comprising a voltage pulse generating circuit configured to generate a voltage pulse of a desired voltage level and a desired pulse frequency from an input voltage; an output monitoring circuit connected to the output side of the voltage pulse generating circuit, the output monitoring circuit operable to detect at least one of the following operational parameters: an output voltage level, an output voltage ramping rate, an output current level; and an electronic controller arranged in data communication with the voltage pulse generating circuit and the output monitoring circuit, the electronic controller operable to receive the detected operational parameter and to control operation of the voltage pulse generating circuit based on based on per-determined rule.

In some embodiments, the voltage sensing module comprises a voltage divider, wherein the output voltage level is divided by a pre-determined number for measurement.

In some embodiments, the electronic controller is operable to selectively activate the voltage pulse generating circuit based on the detected voltage level.

In some embodiments, after the voltage pulse generating circuit is activated and in a transient state before the output voltage reaches the desired voltage level, the electronic controller is operable to selectively deactivate the voltage pulse generating circuit based on the detected output voltage ramping rate.

In some embodiments, in a steady state where the desired voltage level is reached, the electronic controller is operable to selectively deactivate the voltage generating circuit based on the detected output current level.

In some embodiments, the voltage pulse device comprises a stimulating probe for conducting the voltage pulse to a root portion of at least one of the plurality of plants.

Other aspects of the disclosure will be apparent to those of ordinary skill in the art upon review of the following description of specific embodiments of the disclosure in conjunction with the accompanying drawings.

### BRIEF DESCRIPTION OF THE DRAWINGS

Various embodiments are described, by way of example only, with reference to the accompanying drawings.

FIG. 1 illustrates a negative air ion generation system according to one embodiment.

FIG. 2 illustrates a negative air ion generation system according to another embodiment.

FIGS. 3A and 3B, FIGS. 4A and 4B illustrate use of the negative air ion generation systems of FIGS. 1 and 2 for air purification according with some embodiments.

FIG. 5 illustrates a negative air ion generation system according to another embodiment.

FIGS. 6A and 6B illustrate a negative air ions emission profile measured for the system of FIG. 5.

FIG. 7A to 7F illustrate use of the negative air ion generation system of FIG. 5 for air purification according with some embodiments.

FIGS. 8A and 8B illustrate a negative air ion generation system according to another embodiment and a negative air ions emission profile measured for the system.

FIG. 9 illustrates a negative air ion generation system according to another embodiment.

FIG. 10 to FIG. 12B illustrate use of the negative air ion generation system of FIG. 9 for air purification according with some embodiments.

FIG. 13 is a schematic block diagram of a voltage pulse device of the negative air ion generation system.

FIG. 14 illustrates a normal operating range of the voltage and current output of the voltage pulse device.

FIG. 15 illustrates an exemplary circuit implementation of the voltage pulse device.

FIG. 16 is a flow chart showing an exemplary implementation of the decision-making process in the electronic controller of the voltage pulse device.

### DETAILED DESCRIPTION

In the following description, details are provided to describe the embodiments of the specification. It shall be apparent to one skilled in the art, however, that the embodiments may be practiced without such details.

Similar parts of the embodiments may have the same names, similar part numbers, or similar part numbers with an alphabet symbol or prime symbol. The description of one part applies by reference to another similar part, where appropriate, thereby reducing repetition of text without limiting the disclosure.

Throughout this specification, unless otherwise indicated to the contrary, the terms ‘comprising’, ‘consisting of’, ‘having’ and the like, are to be construed as non-exhaustive, or in other words, as meaning ‘including, but not limited to’.

Throughout the specification, unless the context requires otherwise, the word ‘include’ or variations such as ‘includes’ or ‘including’ will be understood to imply the inclusion of a stated integer or group of integers but not the exclusion of any other integer or group of integers.

Throughout the specification, certain embodiments may be disclosed in a range format. It should be understood that the description in range format is merely for convenience and brevity and should not be construed as a limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. Ranges are not limited to integers, and can include decimal measurements. This applies regardless of the breadth of the range.

Throughout the specification, the singular form “a”, “an” and “the” include plural references unless the context clearly dictates otherwise. For example, the term “a plant” or “at least one plant” may include a plurality of plants.

Referring to the term “electronic controller” or “processor” or “micro-controller”, it includes, but is not limited to, a microchip configured to execute operating logic that defines various control, management, and/or regulation functions. This operating logic can be in the form of software, firmware, and/or dedicated hardware, such as, a series of programmed instructions, code, electronic files, or commands using general purpose or special purpose programming languages, and/or a different form as would occur to those skilled in the art.

Unless defined otherwise, all other technical and scientific terms used herein have the same meaning as is commonly understood by a skilled person to which the subject matter herein belongs.

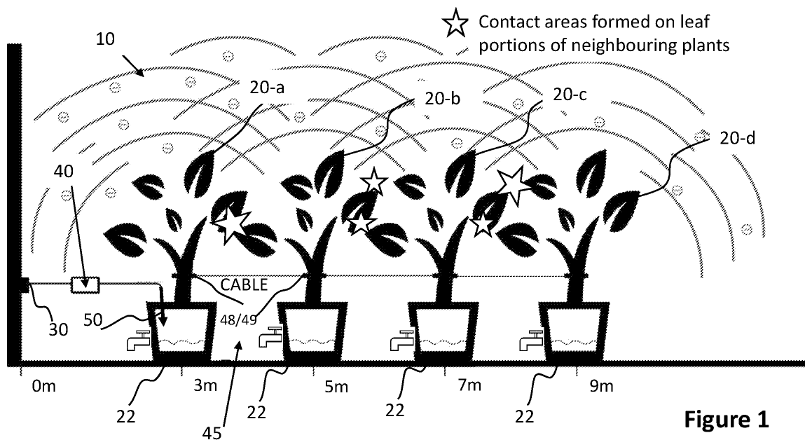

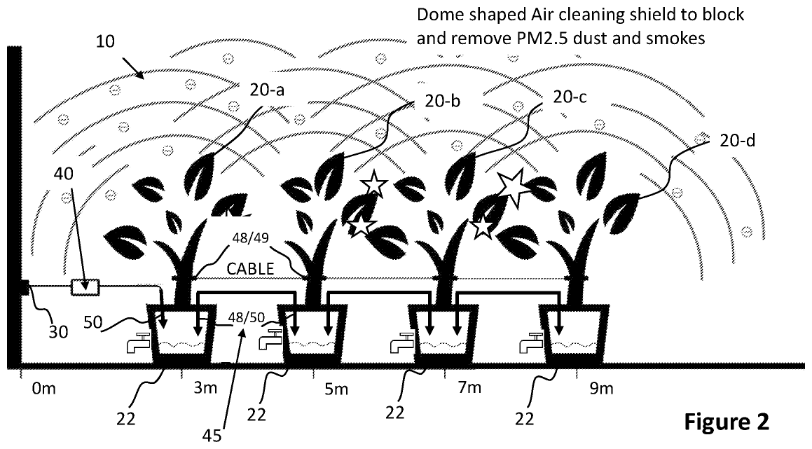

In accordance with various embodiments of the invention and with reference to FIG. 1 and FIG. 2, there is a system 10 for air purification. The system 10 is a plant-based negative air ion generation system 10 where plants are stimulated by a suitable voltage pulse to emit negative air ions (NAIs) to the surrounding environment. Among other health benefits, precipitation of particulate matter in the surrounding environment can be enhanced due to the negative air ions generated by the plants, and air quality can be improved.

The system 10 comprises at least a first plant 20-a and a second plant 20-b, and a voltage pulse device 40 connectable to a power source and operable to generate and transmit a voltage pulse to the first plant 20-a, wherein the first plant 20-a is connected to the second plant 20-b using at least one voltage pulse transmission unit 45, and the first plant 20-a and the second plant 20-b are arranged to form one or more contact areas at a leaf portion. More specifically, a leaf portion of the first plant 20-a and a leaf portion of the second plant 20-b are configured to form one or more contact areas.

In various embodiments as shown in FIG. 1 and FIG. 2, the first and second plant 20-a, 20-b may be cultivated in plant pots 22. In various embodiments, the plant pots 22 may be any commercial plant pots. Depending on the system requirements (e.g., the size of the plants, and/or any space constraint), plant pots 22 of different shapes and different sizes may be used for holding and cultivating the respective plant 20-a, 20-b, 20-c and etc.

In some embodiments, the plant pots 22 may be customized plant pots specifically designed and/or modified for use in the system 10. For example, a plant pot 22 for containing the first plant 20-a may be configured with a cavity on the side wall or on the rim, wherein the cavity is shaped and sized for receiving the voltage pulse device 40. In other words, the voltage pulse device 40 may be attached/mounted onto or otherwise integrated with the plant pot 22.

In various embodiments, the system 10 may comprise one or more types of plants 20. Non-limiting examples of plants which may be used in the system 10 for generating negative air ions include Snake Plant (or Sansevieria trifasciata), Dragon Plant (or Dracaena marginata), Bamboo Plant (or Dracaena surculosa), Peace Lily (or Spathiphyllum), and Areca Palm (or Dypsis lutescens). It is to be appreciated that the first plant 20-a and the second plant 20-b may be the same type of plant or may be two different types of plant, and that the system 10 may include one or more other plants (e.g., the plants 20-c, 20d as shown in FIG. 1 and FIG. 2) that are directly or indirectly connected to the first plant 20-a via the at least one voltage pulse transmission unit 45.

In various embodiments, the voltage pulse device 40 operates to generate a pre-determined voltage pulse V_{OUT} from an input voltage VINT as derived from the power source 30. In various embodiments, the voltage pulse V_{OUT} may be a negative voltage pulse of a suitable amplitude for stimulating the plants 20.

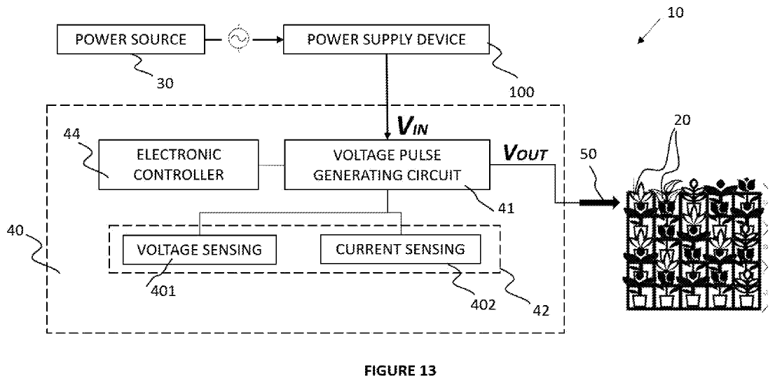

As shown in FIG. 13, the voltage pulse device 40 comprises a voltage pulse generating circuit 41 configured to produce a voltage pulse V_{OUT} of desired pulse characteristics, in particular a desired voltage level and a desired pulse frequency. A non-limiting example of the voltage pulse generating circuit 41 may be a medium-high voltage pulse generating circuit based on the field-effect transistor technology, wherein a field effect transistor (e.g. a MOSFET switch) may be driven by a micro-controller (e.g. a single-chip micro-controller) to first output a low power modulation driving signal, which may be boosted to a higher voltage/power level (e.g. by using a boost converter) and then be rectified into the desired negative voltage pulse V_{OUT} for stimulating the plant 20.

In various embodiments, a voltage level of the voltage pulse V_{OUT} generated by the voltage pulse device 40 may be between −2 kV to −48 kV. In some embodiments, a voltage level of the voltage pulse V_{OUT} is between −3.5 kV to −18 kV. In various embodiments, the voltage pulse device 40 may be set/configured to output a voltage pulse V_{OUT} of different voltage levels depending on the system requirements, such as the type of the plants 20, the size of the plants 20 and/or the plant pots 22, as well as the number of plants 20 used in the system 10.

In some embodiments and with reference to FIG. 13 to FIG. 16, the voltage pulse device 40 comprises an output monitoring circuit 42 connected to an output side of the voltage pulse generating circuit 41. The output monitoring circuit 42 is configured to monitor the operational state of the voltage pulse device 40. One or more operational parameters of the voltage pulse device 40, including an output voltage level, an output voltage ramping rate and additionally an output current level, may be detected by the output monitoring circuit 42.

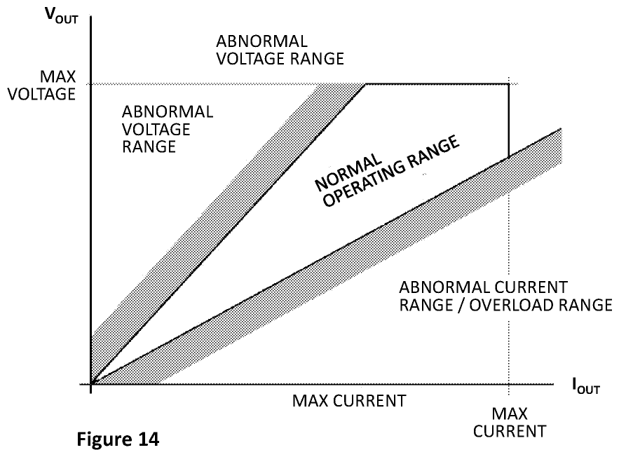

A normal operating range of the voltage pulse device 40 is pre-defined by a set of operating limits and may be pre-stored in the voltage pulse device 41. The operational parameters measured by the output monitoring circuit 42 may then be compared against the pre-defined operating limits for determining whether the voltage pulse device 40 is operating within the normal operating range. As shown in FIG. 14, the voltage pulse device 40 is considered to operate within a normal operating range when neither the output voltage V_{OUT} nor the output current I_{OUT} is detected to exceed a pre-defined voltage/current limit. An abnormally high output voltage level or an abnormally high output current level detected by the output monitoring circuit 42 may indicate that the voltage pulse device 40 is faulty and/or that there is an abnormality at the load/plant side.

In various embodiments, the output monitoring circuit 42 comprises a voltage sensing module 401 connected to a voltage output line of the voltage pulse generating circuit 41 for detecting an output voltage level V_{OUT} of the voltage pulse device 40.

In various embodiments, the output monitoring circuit 42 may further comprise a current sensing module 402 connected to a ground reference line of the voltage pulse generating circuit 42 for detecting an output current level I_{OUT} of the voltage pulse device 40.

In various embodiments, the voltage pulse device 40 may comprise an electronic controller 44 arranged in data communication with the voltage pulse generating circuit 41 and the output monitoring circuit 42. The electronic controller 44 may include suitable hardware components such as a microcontroller unit (MCU), microprocessors, coprocessors, digital signal processors (DSP), or control circuits implemented in the form of integrated circuits (IC) chips (e.g., an Application Specific Integrated Circuit or ASIC). The output monitoring circuit 42 transmits information/data pertaining the output voltage level V_{OUT} and the output current level I_{OUT} to the electronic controller 44. The electronic controller 44 operates to process the voltage and current measurement data and may integrate the measurement data for further processing, for example, generating digital commands based on the measurement data.

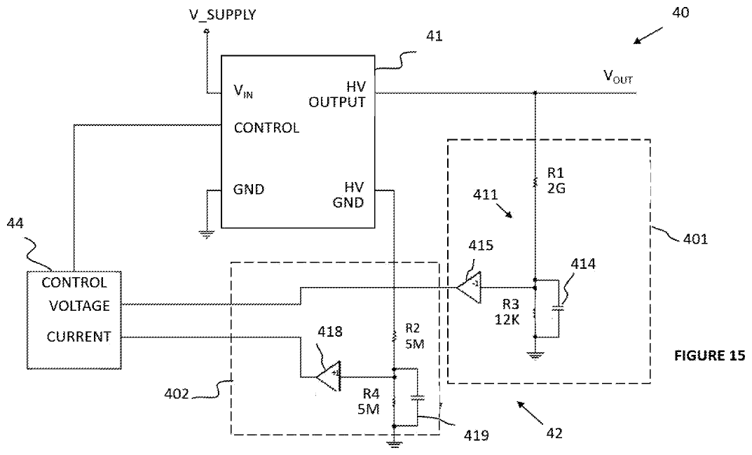

FIG. 15 illustrates an exemplary circuit arrangement of the voltage pulse device 40 which comprises an output monitoring circuit 42 configured to measure the output voltage and current level.

The voltage sensing module 401 of the output monitoring circuit 42 is arranged in parallel connection with the high-voltage output line (denoted as HV Output in FIG. 15) of the voltage pulse generating circuit 41. Due to the high output voltage level of the voltage pulse generating circuit 41 (e.g., in a range of between −2 kV to −48 kV), a voltage divider 411 is used to reduce the high output voltage V_{OUT} to a lower voltage level suitable for measurement. As can be seen in FIG. 15, the voltage divider 411 is a linear circuit comprising two series resistors R1 and R3, one resistor R1 being a high voltage axial resistor and another resistor R3 having a substantially lower resistance value as compared to R1. In the exemplary circuit arrangement of FIG. 15, R1 is a 2G Ohm (giga-ohm) resistor and R3 is a 12K Ohm (kilo-ohm) resistor. It is understood that the voltage divider 411 operates to distribute the relatively high output voltage V_{OUT} among the two resistors R1 and R3 of the voltage divider 411, and the output voltage level is divided by a pre-determined number according to the resistance value of the corresponding resistors R1 and R3 in the voltage divider 411.

The voltage sensing module 401 may comprise an inverting operational amplifier 415 connected to the voltage divider 411 at after the high voltage resistor R1. Functionally, the inverting operational amplifier 415 is operable to convert the negative voltage output from the voltage divider 411 to a positive voltage signal for the electronic controller 411. At the same time, the inverting operational amplifier 415 also functions as a buffer to match the impedance from the source (e.g., from the voltage divider 411) with the input impedance of the electronic controller 44 (for example, an input impedance of an analog-to-digital converter or ADC in the electronic controller 44), such that input impedance of the electronic controller 44 does not significantly affect the voltage measured. Advantageously, the voltage divider 411 and the inverting operational amplifier 415 work together to adapt the high voltage output V_{OUT} to a suitable voltage signal input for the electronic controller 411. Also, as the inverting operational amplifier 415 may also function as a buffer for transfer the voltage signal input to the electronic controller 44, a separate buffer circuit will not be required for the electronic controller 44, and the components of the electronic controller may be reduced.

It is to be appreciated that the inverting operational amplifier 415 may be a unity gain amplifier or a multi-gain amplifier. Depending on the voltage level produced from the voltage divider 411 and the voltage level workable or acceptable for the electronic controller 44, the inverting operational amplifier 415 may be configured to perform a voltage gain adjustment, so as to adjust the voltage to a range that the electronic controller 44 can work with.

The voltage sensing module 401 may further comprise a filter capacitor 414 for providing a cut-off frequency for voltage sensing, e.g., to filter out high frequency noise from getting into the operational amplifier 415. The voltage signal is transmitted from the inverting operational amplifier 415 to the electronic controller 44 for further processing.

The current sensing module 402 is configured to connect the ground reference line (denoted as HV GND in FIG. 15) of the voltage pulse generating circuit 41 to a ground line (denoted as GND in FIG. 15) via two shunt resistors R2 and R4. Accordingly, the shunt resistors R2 and R4 form a low-resistance path for an electric current to flow through for measurement. It is to be appreciated that the resistance value of R2 and R4 is chosen so that the resultant voltage drop across the shunt resistors is measurable, but low enough not to disrupt the voltage pulse generating circuit 41. Also, it is to be appreciated that the current sensing module 402 does not require a high voltage resistor as used in the voltage sensing module 401, because the voltage level at the ground reference line is substantially lower as compared to the voltage level at the output voltage line (typically in kilovolt range).

Optionally, a non-inverting operational amplifier 418 may be used in the current sensing module 402 to boost the voltage signal input for the electronic controller 44. Further, similar to the voltage sensing module 401, a filtering capacitor 419 can be used to filter out high frequency noise from getting into the non-inverting operational amplifier 418. The voltage signal is then transmitted from the non-inverting operational amplifier 418 to the electronic controller 44 for further processing. In the exemplary circuit arrangement of FIG. 15, both shunt resistors R2 and R4 have a resistance value of 100K Ohm (kilo-ohm), and accordingly the voltage drop across each shut resistor is around 1V, which is within the workable range for the electronic controller 44. By monitoring the voltage drop across the shunt resistors, the output current level can be obtained because the voltage is proportional to the current flowing through and can be accurately converted to a current value at the electronic controller 44.

In various embodiments, the electronic controller 44 of the voltage pulse device 40 is operable to receive at least one of the operational parameters from the output monitoring circuit 42 and to control operation of the voltage pulse generating circuit 41 according to a per-determined rule. More specifically, the electronic controller 44 is configured to determine an operational status according to the measurement data received from output monitoring circuit 42, generate a command based on the pre-determined rule (e.g., a set of pre-stored/programmed instructions), and transmit the command to the voltage generating circuit 41 for putting the voltage generating circuit 41 in a desired operational mode (e.g., to activate or de-activate the voltage generating circuit 41).

In some embodiments, the system 10 may further comprise a power supply device 36 for deriving a pre-determined input voltage VIN for the voltage pulse device 40. The power supply device 36 may be in the form of an external power supply device, for example an external power adapter, which may be connected to the voltage pulse device 40 to provide the pre-determined input voltage VIN to the voltage pulse device 40 via a power cable or a power cord. Alternatively, the power supply device 36 and the voltage pulse device 40 may be configured as a built-in module or internal supply of the voltage pulse device 40 which derives the required voltage from the power source 30 as the input voltage for generating the stimulating voltage pulse V_{OUT}. It is to be appreciated that similar circuitry arrangement may be used for both the external power supply device and the built-in/internal power supply device. It is to be appreciated that the circuitry design of the power supply device 36 may be adapted to work with different power sources 30, including mains electricity power used in different countries which are provided at different voltage levels and/or at different alternating frequencies.

In some embodiments, the power supply device 36 may be provided with a voltage stabilizing unit/circuit configured to adjust a reflected voltage from the plants 20. Such a reflected voltage pulse is an opposite pulse reflected back on to the power supply device 36 and the power source 30 due to the floating load in the system (including the plants and the voltage pulse device 30). Advantageously, the voltage stabilizing unit/circuit provides that the impact of the reflected voltage pulse on the power transmission from the power source 30 to the voltage pulse device 40 can be reduced/minimized.

In various embodiments, the voltage pulse device 40 is configured to transmit the voltage pulse to the first plant 20-a. In some embodiments, the voltage pulse device 40 comprises or is used with a stimulating probe 50. The voltage pulse V_{OUT} may be transmitted and released to a root portion of the first plant 20 via the stimulating probe 50. The stimulating probe 50 is an electrode or a conductive electric terminal. The stimulating probe 50 may be configured in an elongated shape to facilitate placement/insertion to the soil. In some embodiments, the stimulating probe 50 may extend from the voltage pulse device 40 directly. In some embodiments, the stimulating probe 50 may be connected to an output interface of the voltage pulse device 40 via a power cable or a power cord.

As shown in FIG. 1 and FIG. 2, the stimulating probe 50 may be inserted into a soil contained in the plant pot 22-a from above the soil. It is to be appreciated that the stimulating probe 50 may also be inserted into the soil media via an opening/pathway on a bottom surface or on a side wall of the plant pot 22, such that it is positioned near or close to the root portion of the plant 20. It is to be appreciated that the voltage pulse from the voltage pulse device 40 may also be transmitted to the first plant 20-a in other suitable manner, for example, by attaching a conductive terminal directly onto a stem portion of the plant 20-a.

In various embodiments, the first plant 20-a and the second plant 20-b are connected using at least one voltage pulse transmission unit 45 configured to facilitate inter-plant voltage pulse transmission. The first plant 20-a, when stimulated by the negative voltage pulse V_{OUT}, may emit more negative air ions to the surrounding environment. Further, at least part of the voltage pulse V_{OUT} is transmitted from the first plant 20-a to the second plant 20-b via the at least one transmission unit 45, so that the second plant 20-b is simultaneously stimulated to emit negative air ions.

In various embodiments, the voltage pulse transmission unit 45 may comprise an electrical cable or an electrical wire with two conductive terminals 48. In use, the conductive terminals 48 may be attached to and/or connected with a designated part of the first plant 20-a and of the second plant 20-b respectively, so that an electrical connection between the first plant 20-a and the second plant 20-b may be formed. The conductive terminal 48 acts as an electrical interface to deliver the stimulating voltage pulse to the designated part of the plants 20-a, 20-b, while the electrical cable 47 acts to conduct/transmit the voltage pulse between the plants 20-a, 20-b.

In various embodiments, the voltage pulse transmission unit 45 may be configured to transmit the voltage pulse from a stem portion or a root portion of the first plant 20-b to a stem portion or a root portion of the second plant 20-b.

In some embodiments and with reference to FIG. 2, the conductive terminals 48 are configured to be inserted or otherwise placed in the soil media of the first plant 20-a and the second plant 20-b, respectively. The conductive terminal 48 may be an electrode in an elongated shape for facilitating insertion into the soil media. This is similar to the stimulating probe 50 used for transmitting the voltage pulse from voltage pulse device 40 to the soil portion of the first plant 20-a.

In some embodiments and with reference to FIGS. 1 and 2, the conductive terminals 48 are configured to be connected to a stem portion of the first and second plants 20-a, 20-b, respectively. As shown in FIG. 1, the conductive terminals 48 may be two metal clamps 49 attachable to the trunk of the first plant 20-b and the second plant 20-b. Since voltage pulse transmission is through the stem portions of the plants (e.g., without passing through the soil media), the overall electrical resistance of the system 10 may be reduced. Advantageously, efficiency of the inter-plant voltage pulse transmission may be improved.

Depending on the size and type of the plant, the conductive terminal 48 of the voltage pulse transmission unit 45 may be configured in other suitable forms for attaching/connecting to the designated plant part. For example, the stem portion of the plant 20 may be pierced through by thin metallic wires (e.g., as the conductive terminal) to establish the electrical connection between two plants. It is to be appreciated that one or more voltage pulse transmission units 45 may be used for facilitating the inter-plant voltage pulse transmission. It is also to be appreciated that the electrical cable may be provided in a suitable length which corresponds substantially to the inter-plant distance.

In use, after the voltage pulse device 40 is activated, the stimulating voltage pulse V_{OUT} is generated and is transmitted to the first plant 20-a and to the second plant 20-b via the at least one voltage pulse transmission unit 45. In embodiments where the system 10 comprises one or more other plants directly or indirectly connected to the first plant 20-a (for example, plants 20-c, 20d as shown in FIGS. 1 and 2), the voltage pulse (or at least part of the voltage pulse) may be transmitted to the one or more other connected plants. The plants of the system 10 are simultaneously stimulated by the voltage pulse to generate and emit negative air ions for air purification.

In various embodiments, the first plant 20-a and the second plant 20-b are arranged to form one or more contact areas at a leaf portion. Advantageously, the one or more contact areas at the leaf portion provide inter-plant voltage transmission paths as an alternative of or in addition to the voltage pulse transmission unit 45, which allows the voltage pulse to be transmitted between the first plant 20-a and the second plant 20-b more efficiently.

Further, when the plants 20 are excited by the stimulating voltage pulse, electrical charge (including electrons and negative air ions) are predominately generated at the leaf portion, in particular, at the leaf tips of the plants, due to the plant geometry. As the leaf portions of the first plant 20-a and the second plant 20-b are arranged to be in contact and/or in close vicinity, the electrical charges emitted by the first plant 20-a may stimulate the leaf portion of the second plant 20-b, and vice versa. In other words, the area around the leaf portion of the various plants 20 contains a substantial amount of negative electrical charge, which may act as a further source of stimulating electrical field for the plants 20 (particularly the plant leaves) to generate negative air ions. Advantageously, the overall negative air ions generation rate of the system 10 is improved. Each plant 20 that is directly or indirectly connected to the voltage pulse device 40 in the system 10 may generate negative air ions that diffuse into the surrounding environment and cause PM2.5 (among other particulate air pollutants) to precipitate faster. As can be seen in FIG. 1 and FIG. 2, each plant 20 acts as a natural source of negative air ions, creating a volume of ionized air surrounding the plant 20 with the concentration of negative air ions being the highest at the plant's leaf portion and gradually decreasing at locations further from the plant source 20.

The system 10 operates on a relatively low current level, e.g., the electrical current flowing through the different plants 20 is of a substantially low amplitude (typically at around 10 μA or below under normal operating condition). Due to the low current level, the voltage level does not drop substantially as the voltage pulse gets transmitted to plants 20 that are located further away from the first plant 20-a. Therefore, an efficient inter-plant voltage pulse transmission may be achieved using the voltage pulse transmission unit 45. Also, the contact areas formed at leaf portions of adjacent plants 20 acts to further enhance inter-plant transmission and the negative air ion generation efficiency of the system 10.

Safety considerations are taken into account during the operation of the system 10, especially when the system 10 is implemented in an outdoor and/or a relatively uncontrollable environment.

Firstly, the system 10 may be prone to electrical overload in an uncontrolled environment. In use, the voltage pulse device 40 works to pump negative charge into the load side (e.g., the interconnected plants 20) until it reaches the target voltage level, which is typically in the kilovolt range. To maintain safety, the voltage pulse device 40 is configured to operate at an extremely low power level, and preferably well under 1 W (Watts) output. Accordingly, the output current level Ian of the voltage pulse device 40, as may be measured by the build-in current sensing module 402, is typically in the microampere range under normal operating conditions. In addition to controlling the power output of the voltage pulse device 40, it is also important to monitor the load condition to make sure that the total energy drawn by the system 10 is below a threshold level where the system 10 may safely operate and where the potential for harm to a user due to electrical shocks or burns may be reduced.

Further, in a system 10 where multiple voltage pulse devices 40 are used for stimulating a large number of plants 20 or in a potential use case where multiple systems 10 operate in close proximity, there may be a relatively higher risk of exceeding the energy threshold level and delivering a dangerous electrical shock to the user. This is because the plants 20 grow over time and isolation gaps of the plants 20 connected to the different voltage pulse devices 40 may close up, leading to the connection of the outputs of the multiple voltage pulse devices 40. Even when the load condition is normal and no unexpected connection of multiple voltage pulse devices 40 has incurred, the voltage pulse device 40 itself may over time store enough energy to be dangerous if the device 40 comprises or is connected to any components with a large enough capacitance (for example, a significantly sized capacitor).

The system 10 is advantageous in that the energy discharge and delivery process is well controlled by the voltage pulse device 40 to minimize risks to the user. This is primarily achieved by implementing an output monitoring circuit 42 in the voltage device 40 to measure a set of operational parameters of the voltage pulse device 40. The measured operational parameters are used by the electronic controller 44 for putting the voltage pulse device 40 in a desired operational mode, for example to trigger a power safety cut-out switch (not shown) to deactivate the voltage pulse generating circuit 41.

In various embodiments, the output monitoring circuit 42 is operable to detect at least one of the following operational parameters of the voltage pulse device 40: an output voltage level, an output voltage ramping rate, an output current level.

In some embodiments, the electronic controller 44 is operable to selectively deactivate the voltage generating circuit 41 based on the detected output voltage level.

In some embodiments, the electronic controller 44 is operable to selectively deactivate the voltage pulse generating circuit 41 based on the detected output voltage ramping rate, after the voltage pulse generating circuit 41 is activated and in a transient state before the output voltage reaches the desired voltage level.

In some embodiments, the electronic controller 44 is operable to selectively deactivate the voltage generating circuit based on the detected output current level in a steady state where the desired voltage level is reached.

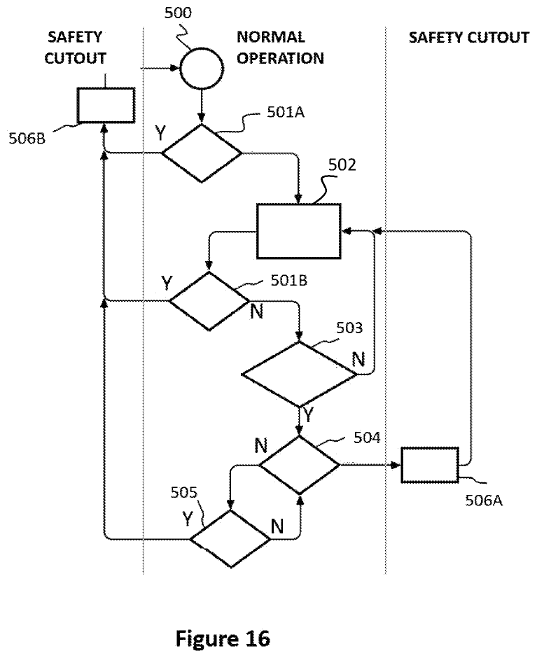

An exemplary implementation of a decision-making process by the electronic controller 44 is illustrated in the flow chart of FIG. 16. Control mechanisms are implemented at different stages during the operation of the voltage pulse device 40 to determine whether the voltage pulse device 40 is operating within a normal operating range and if a power safety cutout needs to be triggered.

At a start-up step 500 where the voltage pulse device 40 is first powered on, the output monitoring circuit 42 is configured to measure the voltage level V_{OUT} at the output side of the voltage generating circuit 41. At this stage, the output voltage level V_{OUT} is expected to be low, e.g., near the GND potential. In a decision-making step 501A, the electronic controller 44 determines whether the measured output voltage level V_{OUT} is unexpectedly high, e.g., exceeding a pre-determined voltage limit for the start-up stage. This may indicate that one or more plants 20 in the system 10 are already connected to and are driven/stimulated by another voltage pulse device 40 in operation. Accordingly, the electronic controller 44 may operate to deactivate the voltage pulse generating circuit 41, for example, by triggering a power cutout switch. The voltage generating process may be either aborted or delayed. In this decision-making step 501A, if the electronic controller 44 determines that the output voltage level V_{OUT} is in the normal operating range (e.g., comparable to the GND potential), the voltage pulse generating circuit 41 will continue to ramp up the voltage towards the target voltage level in step 502.

In a transient state while the voltage output rises up to the target voltage level, a voltage ramping rate is monitored. More specifically, the output monitoring circuit 42 may be configured to measure the output voltage level V_{OUT} at pre-determined time intervals, from which the electronic controller 44 may calculate the voltage ramping rate. In this transient state or the voltage ramping stage, the output current level is very low by design. Therefore, if the voltage ramping rate is abnormally high, e.g., if the voltage rises too fast, the system 10 may be in an under-loaded condition. This may occur, for example, when the voltage pulse device 40 is not properly connected to the load, and/or when the stimulating probe 50 and/or the voltage pulse transmission unit 45 are not properly set up to connect the various plants 20. On the other hand, if the voltage ramping rate is abnormally slow, the voltage pulse device 40 may be connected to a dangerously high load capacitance. Accordingly, a further decision-making step 501B is implemented in the electronic controller 44 to deactivate the voltage pulse generating circuit 41 when the voltage ramping rate is outside the normal operating range. The voltage generating process may be either aborted or delayed. In this decision-making step 501B, if the electronic controller 44 determines that the voltage is ramping up at a normal rate, the voltage ramping continues to reach the target voltage level before the electronic controller 44 proceeds to a further decision-making step 503.

In the decision-making step 503, the electronic controller 44 is configured to check whether the target voltage level has been reached. If the output voltage level V_{OUT} measured at the end of the voltage ramping stage is lower than the target voltage level, the voltage pulse generating circuit 41 may be controlled to repeat the voltage ramping until the target voltage level is reached. Once the output voltage has ramped up to the target voltage level, the voltage pulse device 40 is operating in a steady state to deliver the voltage pulse to the connected plants 20.

In a further decision-making step 504, the electronic controller 44 is configured to determine a load condition based on the output current level I_{OUT} detected by the current sensing module 402. During the operation, if the output current level I_{OUT} is too low (as evaluated in step 505), it may indicate that the system 10 is in an underload condition. On the contrary, if the output current level is too high, the system 10 may be in an overloaded condition, for example, the system 10 may be accidentally connected to a grounded metal work which draws a large current from the voltage pulse device 40, or a user may be touching the stimulated plants 20, or the plants 20 may be touching other structures (such as a wall) in the vicinity. Step 505 determines if the current is too low. The electronic controller 44 operates to deactivate the voltage pulse generating circuit 41 when the voltage ramping rate is outside the normal operating range via step 506A where the current is too high and step 506B if the current is too low (in either event the power is turned off and there is a delay.

In each of the above processes, the electronic controller 44 may be configured to also trigger an alarm to alert the user, and/or to trigger a notification to be sent to the user.

In some embodiments, the system 10 may further comprise a proximity sensing module configured to detect an intruding subject in the vicinity of the plants 20. The proximity sensing module comprises one or more of the following proximity sensors: active infrared proximity sensor, passive infrared proximity sensor, radio frequency proximity sensor, laser proximity sensor, time-of-flight (ToF) proximity sensor, inductive proximity sensor, capacitive proximity sensor. In some embodiments, the system 10 may further comprise a touch sensing module configured to detect a subject coming in contact with the plant.

In some embodiments, the electronic controller 44 of voltage pulse device 40 or a separate controller unit may be configured to control operation of the system 10 based on data from the proximity sensing module and/or from the touch sensing module, for example, to generate a sound alarm when a person is detected to be within a “fencing zone” formed by the proximity module and/or to switch off the voltage pulse device 40 when a person touches a plant part. The proximity sensing module and the touch sensing module provide for additional safety measures to prevent a person in the vicinity of the system from getting electric shocks by the ionized plants 20.

It is to be appreciated that the system 10 and/or the voltage pulse device 40 may further include other functional modules as may be conceived by a skilled person. For example, the system 10 may comprise a display module (e.g. a display screen, one or more LED light indicators) for displaying information about the system 10 to a user, a control panel for controlling the operation of the system 10, an audio unit (e.g. a speaker or buzzer) for communicating an audio message to the user (e.g. an audio alarm in case of device mal-function, upon detection that the voltage pulse device 40 is not operating within its normal operating range, upon detection of an intruding person, and etc.).

In some embodiments, the system 10 may also include a communication unit configured to connect to a network interface through which data communication/internet connectivity with other network-connected devices (e.g., one or more external user devices, one or more other systems 10 placed at different locations, a PM2.5 sensing device for collecting air quality data in the surrounding environment) may be established. The network-connected system 10 may interact and cooperate with other devices in a cloud computing environment to form an Internet-of-Things (IoT) cloud system.

The system 10 may be implemented in various indoor and outdoor settings for air purification.

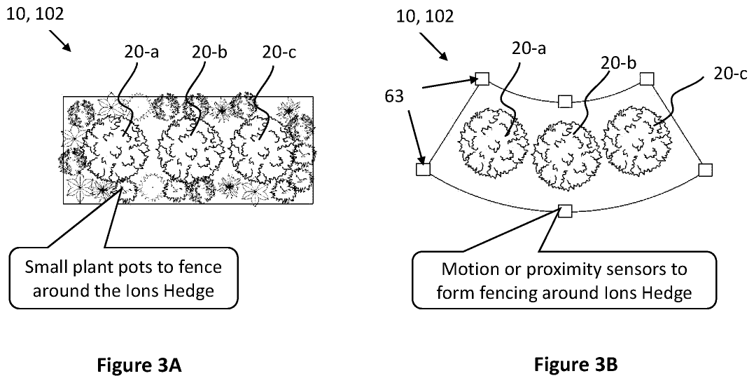

With reference to FIGS. 3A and 3B, the system 10 comprises plants 20-a, 20-b, 20-c that are arranged in a row. The plants 20-a, 20-b, 20-c may be connected in a similar manner as shown in FIG. 1 or FIG. 2. Alternatively, the plants 20-a, 20-b, 20-c may be configured to connect with each other using the voltage pulse transmission unit 45. In use, the voltage pulse device (not shown) may be configured to transmit the generated voltage pulse V_{OUT} to any one of the plants (for example, plant 20-a), which will be simultaneously transmitted to the other two inter-connected plants (for example, plants 20-b, 20-c). The system 10 arranged in this configuration is also referred to as an ions hedge 102.

In some embodiments as shown in FIG. 3A, the ions hedge 102 may further include a plurality of non-ionizing plants, e.g., plants that are not connected with any voltage pulse device and are thus in an un-excited or non-ionizing state. The non-ionizing plants may be potted plants that are of a relatively smaller size than the ionized plants 20-a, 20b, 20c, which act to provide a fence around the ionized plants 20-a, 20b, 20-c. It is to be appreciated that the ions hedge 102 may also include other physical fence, or other types of obstruction to create a safety distance between a person/a user and the ionized plants 20.

In some embodiments as shown in FIG. 3B, the ions hedge 102 may include a proximity sending module comprising multiple proximity sensors 63 for fencing the ionized plants 20-a, 20b, 20-c from unwanted contact with a user or any person that comes in the vicinity of the ions hedge 102. Upon detection of any intruding subject/person within the fencing range of the proximity sensors 63, safety features can be implemented, for example, by automatically cutting off power of the system 10 to protect the safety and well-being of the users. The ions hedge 102 may be re-activated automatically at a pre-determined time period and/or when it is detected that the subject/person is no longer inside the fencing range. It is to be appreciated that other types sensors (e.g., motion sensor, touch sensor) which are capable of detecting an intruding subject/person may also be used for providing the same fencing function.

In some embodiments, the system 10 may comprise a ventilation mechanism for facilitating air flow in a pre-determined direction. Also, air flow may be controlled to flow through the system 10 (more specifically, through the air cleaning area of the system 10) at a pre-determined rate.

For air purification in an outdoor environment (e.g., gardens and parks, roadside) and/or in an open-air space (e.g., indoor gathering points, indoor gardens), multiple ions hedges 102 may be utilized.

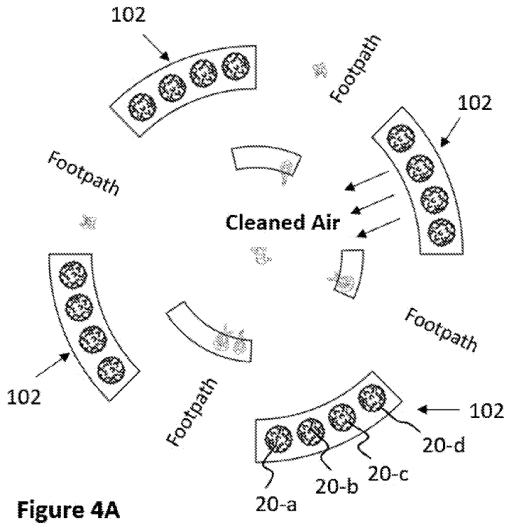

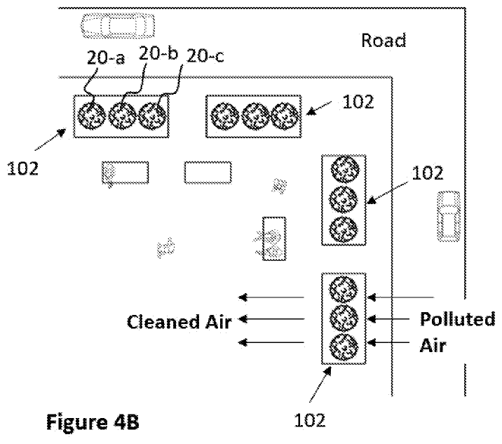

FIG. 4A illustrates using the ions hedge 102 in an indoor garden, where four ions hedges 102 are arranged to form a localized area having multiple magnitude increase in negative air ions. This localized area with cleaned air (e.g., air with reduced PM level due to the high content of negative air ions) is particularly suitable for an indoor gathering point, where patrons and visitors may be effectively protected from any particulate air pollutants.

FIG. 4B illustrates using the ions hedge 102 for reducing vehicular air pollution. Multiple ion hedges 102 are arranged along the roadside and operate to emit negative air ions in the surrounding environment, such that the incoming polluted air from the vehicles are cleaned. Pedestrians and crowds in close proximity to the road are protected from exposure of vehicular air pollution. It is to be appreciated that the ions hedge 102 may be arranged in other manners for reducing vehicular air pollution. For example, the ions hedge 102 may be placed along road dividers that reduces the PM2.5 level generated by vehicles. The ions hedge 102 is particularly suitable for roads that do not have permanent road dividers as it can be deployed and removed with ease. It can also be deployed along roads with permanent road dividers, e.g., with rooted trees and shrubs.

Depending on the specific applications and the requirements on the air cleaning coverage area, the plants 20 of the system 10 may be arranged in various other setups. For example, the system 10 may be arranged in a modular setup or as an assembly which includes a cluster of plants configured to generate a desired negative air ions profile in the surrounding environment. Systems 10 with such modular/assembly setup may be scaled up with ease to provide a relatively larger air cleaning coverage area.

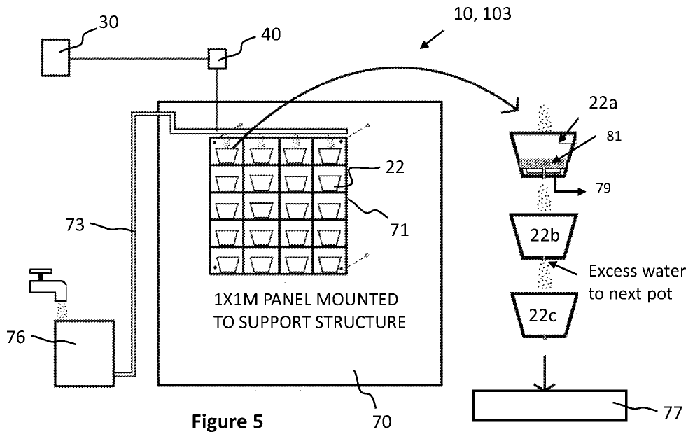

In various embodiments and with reference to FIGS. 5 to 13, the negative air ion generation system 10 comprises a plurality of plants 20 mounted on a support structure 70, and at least one voltage pulse device 40 connectable to a power source 30 for generating and transmitting a voltage pulse to at least one of the plurality of plants 20. Each one of the plurality of plants 20 is connected with another plant 20 using at least one voltage pulse transmission unit (not shown in FIGS. 5 to 15 for brevity), and/or is configured to form one or more contact areas with another plant 20 at a leaf portion thereof. Inter-plant voltage pulse transmission among the plurality of plants is achieved either through the voltage pulse transmission unit or through the contact areas formed at the leaf portion.

The plants 20 may be cultivated in plant pots 22 containing a soil media. For the sake of clarity and brevity, only the plant pots 22 that are used for cultivating the plants 20 are shown in some of the figures. The support structure 70 is configured to hold each of the plurality of plant pots 22 (and therefore the respective plants 20) in a fixed position relative to each other.

In various embodiments, the support structure 70 may comprise one or more planar surfaces, and the plurality of potted plants 20 may be mounted thereon. The planar surface may be in the form of a vertical panel 71 or a wall panel 71 that is attached to the support structure. As shown in FIG. 5, a matrix of potted plants 20 may be arranged in the wall panel 71. The system 10 comprising plants 20 arranged in such a wall panel setup is also referred to as an ions panel 103. It is to be appreciated that the wall panel 71 may be configured in any suitable size and shape (e.g., in a 1×1 meter square shape).

In some embodiments, one single power source 30 and one single voltage pulse device 40 may be used to provide the stimulating electrical power or the voltage pulse to the ions panel 103. In use, the voltage pulse device 40 may be configured to transmit the voltage pulse to any one of the plurality of plants 20, which is shared among the plurality of plants 20 of the ions panel 103. Inter-plant voltage pulse transmission may be achieved between any two of the plurality of plants 20 by connecting the two plants with the at least one voltage pulse transmission unit. Further, plant pots 22 are spaced apart by a suitable distance such that the adjacent plants 22 may form physical contacts at the leaf portion to provide an alternative or additional voltage pulse transmission path between any two plants.

In various embodiments, the system 10 further comprises a watering mechanism that is configured to direct water from a water source to the plurality of plants 20, and to direct excess irrigation water from the plurality of plants 20 to a water collector 77. The watering mechanism may comprise a water channel that is in fluid connection with a water tank 76 (e.g., a water source). Water may be pumped from the water tank 76 and delivered to an area above the plurality of plants 20 through the water channel 73 and may be sprayed onto the plants 20.

In the exemplary system setup as shown in FIG. 5, the plants 20 arranged in the first row of the cluster/matrix of plants 20 receive water directly from the water channel 73 (for example, from the nozzles or sprayers installed on the water channel 73). Each plant pot 22 may be configured with a flow-through system to allow excess water to be drained to another pot 22 directly below and eventually to the water collector 77. The collected excess water can be recycled for irrigating the plurality of plants 20.

In some embodiments, the plant pot 22 may be provided with a cavity 79 for water storage at the bottom part of the plant pot 22 and a layer of expanded clay 81 which may prevent soil from going down to the water storage cavity 79, so that the excess water directed to the second plant pot 22-b is suitable for irrigation. Part of the water is retained in the soil media of a first plant pot 22-a, and excess water is directed to flow through a channel opening at the bottom to a second plant pot 22-b immediately below the first plant pot 22-b. Similarly, any excess water is directed to other plant pots disposed at the lower portion of wall panel 71, and eventually to the water collector 77.

In the ions panel 103, the wall panel 71 with the matrix of plants and the water collector 77 are attached to the support structure 70 and are placed at a distance from the floor. Advantageously, the watering mechanism of the ions hedge 103 prevents any water from flowing to the floor which may cause the ions hedge 103 to be shorted to the earth ground. Further, the voltage pulse device 40 may be configured to detect when the ions hedge 103 is shorted or grounded and automatically cut off the power of the ions hedge 103.

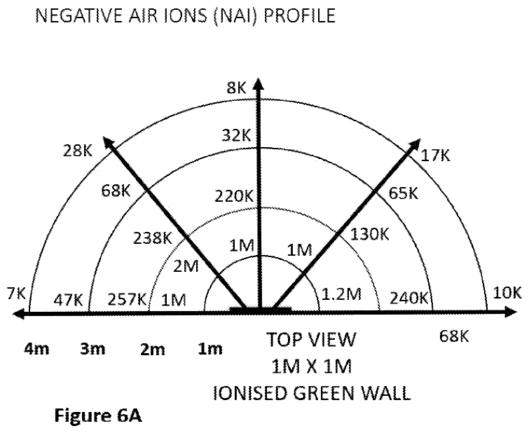

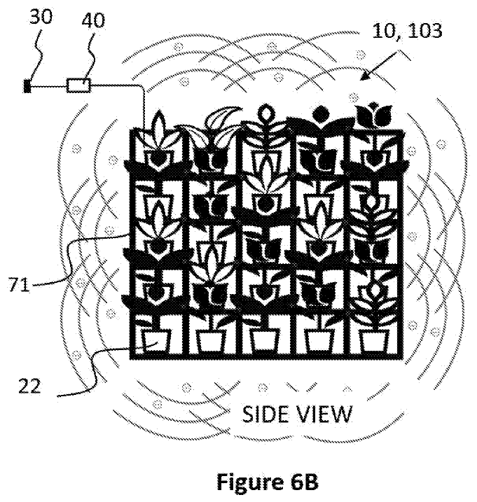

Functionally, the ions panel 103 is operable to generate a dome-shape negative air ions profile, wherein the negative air ions are constantly generated by the plants 20 and gradually diffuse into the surrounding space. The negative air ions profile of a ions hedge 103 comprising a 1×1 meter ions panel 103 is depicted in FIGS. 6A and 6B, which envelops the side and the front of the wall panel 71. The level of negative air ions is measured at various distances from the wall panel 71. It can be seen that the ions hedge 103 is capable of generating a high level of negative air ions in the surrounding environment, with an amount of about 1 million/cm³ to 2 million/cm³ of negative air ions measured at 1 meter away from the center of the wall panel 71 and an amount of 7 K/cm³ to 28 K/cm³ measured at a distance of 4 meters from the wall panel 71. The high level of negative air ions causes the particulate air pollutants including PM2.5 to precipitate and cleans the air in the vicinity of the ions hedge 103. Particularly, when the ions hedge 103 is placed near a pollutant source (for example in a smoking chamber), it is operable to reduce the amount of particulate air pollutants released by the pollutant source. The hazardous effect caused by such a pollutant source is thus minimized by the ions hedge 103. Also, the ions hedge 103 may comprise multiple wall panels 71 that are situated side by side so as to form a larger air cleaning coverage area, which may extend over a substantially large area in the surrounding space. An effective large-scale air purification system is achieved.

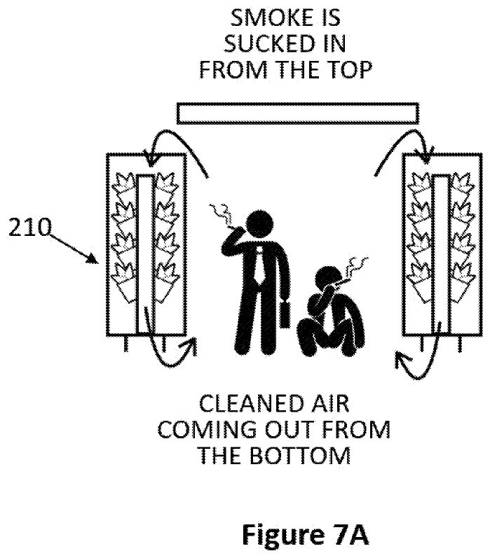

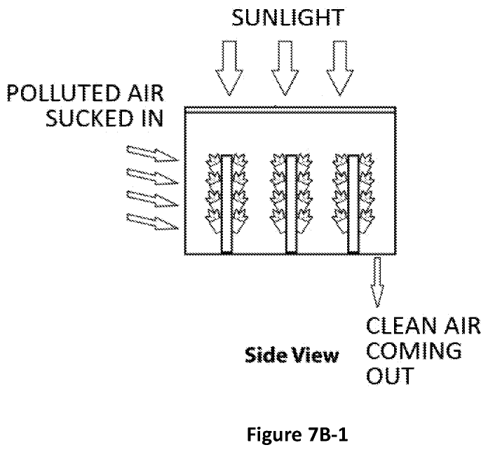

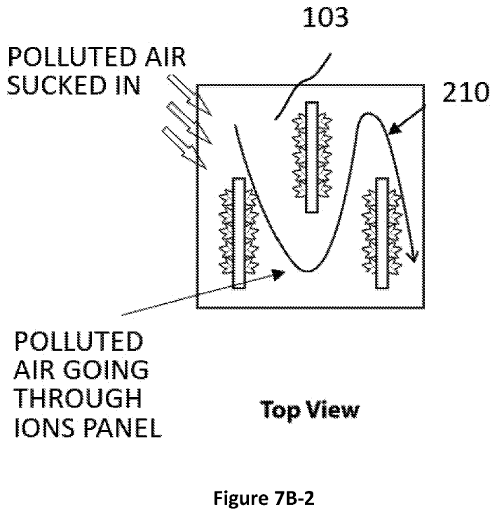

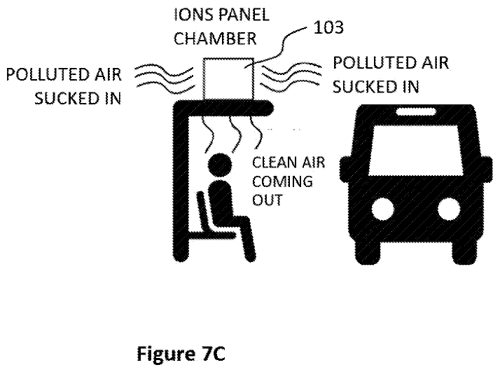

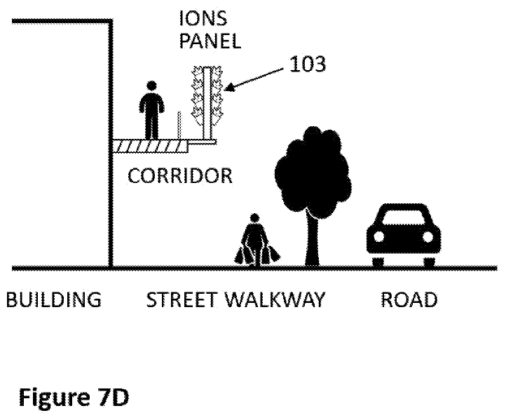

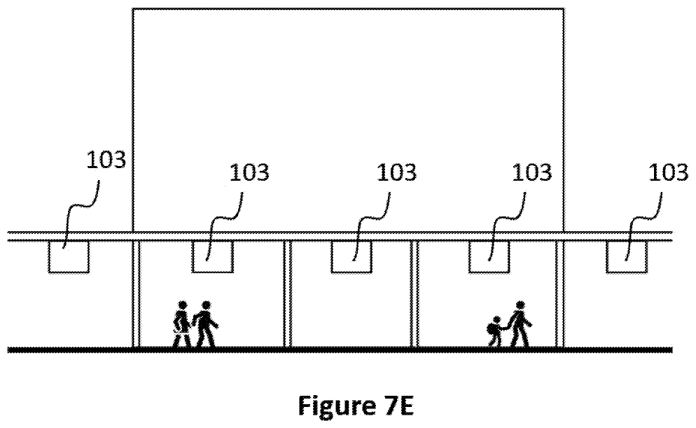

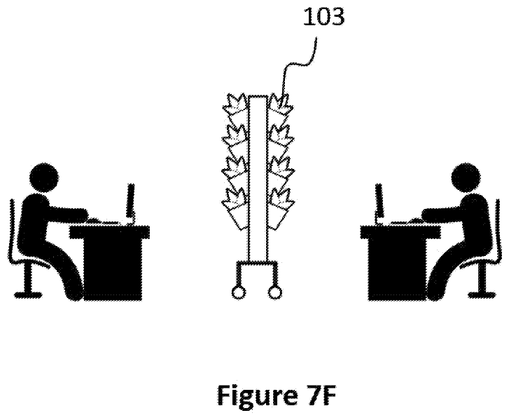

FIG. 7A illustrates a smoking shelter comprising multiple ions panel 103 integrated with or mounted onto one or more walls of the smoking shelter. At smoking points without any air purifier, PM2.5 may reach very unhealthy level and the public may be exposed to secondhand cigarette smoke. The ions panel 103 may improve the air quality for smokers inside the smoking shelter and may also prevent the hazardous cigarette smoke from reaching the public who are around the smoking shelter. As can be seen in FIG. 7A, the ions panel 103 may be provided both on the exterior surface and the interior surface of the walls of the smoking shelter.

The ions panel 103 may be enclosed in a housing or a chamber to physically separate the patrons or smokers from the ionized plant system for safety. This allows a relatively enclosed space with high negative air ions level to be created, which is capable of cleaning particulate air pollutants more efficiently. Each of the enclosed space containing the ions panel 103 is referred to as a filtration chamber 210. A ventilation mechanism may be implemented to facilitate air flow in a pre-determined direction and may also be configured to control the air flow at a pre-determined rate. More specifically, one or more ventilators, fans and/or air pumps may be used to suck the cigarette smoke into the filtration chamber 210 (e.g., from an air entrance at the top of the filtration chamber 210) to filter the air of PM2.5 before the air is circulated back to the smoking shelter (e.g., from an air exit at the bottom of the filtration chamber).

The filtration chambers 210 may be used in other pollutant heavy areas such as smoking rooms, bus stops, or by the roadside. FIGS. 7B-1, 7B-2 and 7C illustrate a further configuration of the filtration chamber 210 and use of such filtration chamber 210 for cleaning air at bus stops.

Given the close proximity and time spent by the commuters at the bus stop, there is high exposure to harmful PM2.5 levels. The filtration chamber 210 can be placed at the roof of the bus stop to take in polluted air from the buses and vehicles. The filtration chamber 210 may have a transparent rooftop to allow photosynthesis and growths of the plants 20. Similar ventilation mechanism is deployed to direct the polluted air to enter the filtration chamber 210 (e.g., from an air entrance at the side wall of the filtration chamber 210), whereby particulate matters in the polluted air is removed while the air passes through the one or more ions panels 103 inside the filtration chamber 210. The filtration chamber 210 will clean the polluted air and vent out clean and fresh air to the commuters waiting at the bus stop. Further, additional ions panel 103 can also be deployed outside of the filtration chamber 210 on the roof to create an air cleaning bubble to trap and remove roadside PM2.5, protecting the commuters within.

In some embodiments, the filtration chamber 210 may be incorporated in existing filtration system to pre-filter the air before being passed through to subsequent filters, for example a high-efficiency particulate air (HEPA) or a high-efficiency particulate absorbing filter. Due to the sheer amount of dust particles in the air, existing filtration systems need to replace filter often. By pre-filtering the air using the filtration chamber 210, frequency of replacing the filter can be reduced. In some embodiments, the filtration chamber 210 may be used with one or more other types of negative air ions generation systems 10. For example, one or more ions panels 103 may be used to pre-filter the air before subjected to a second round of filtering at the filtration chamber 210. In some embodiments, the filtration chamber 210 can also be placed along air vents (at the intake or the exhaust vent) that clean the air passing through.

Other implementations of the ions panel 103 are also contemplated. As shown in FIG. 7D to FIG. 7E, the ions panel 103 may be placed at along walkways, shelters, or open area spaces to provide cleaner ambient for the users. It may also be attached to the side of a building (for example, at balconies, along the corridors and/or on the railings). Particulate air pollutants including PM2.5 may be trapped within the air cleaning coverage area provided by the ions panel 103. The inhabitants behind the ions panel 103 will be protected from any outdoor particulate air pollutants and will be breathing the cleaned air. As shown in FIG. 7F, the ions panel 103 may also be used as partitioning walls to improve the air quality in an office. Alternatively, the ions panel 103 may be configured as a modular, movable green wall divider in the office.

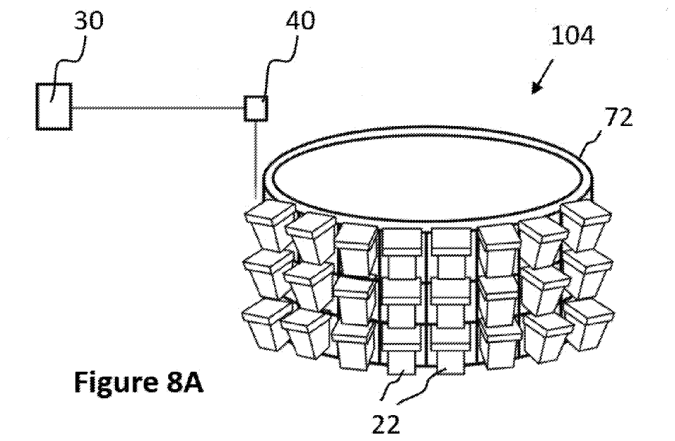

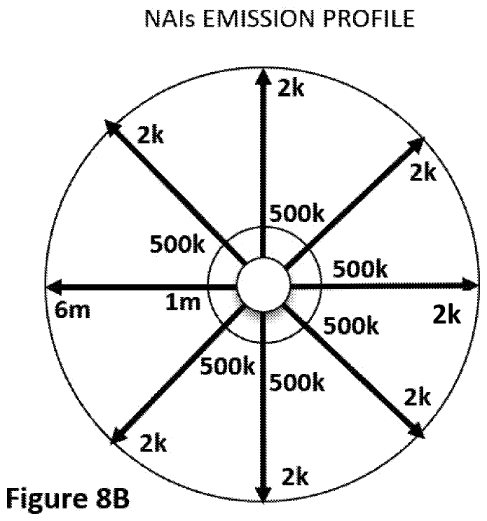

In various embodiments, the support structure 70 of the system 10 may comprise one or more curved surfaces for the plurality of potted plants 20 to be mounted thereon. The curved surface may be in the form of a circular ring frame 72 as shown in FIGS. 8A and 8B. A plurality of plant pots 22 (and therefore the plants 20) may be attached to the exterior surface of the circular ring frame 72. The system 10 comprising plants 20 arranged in this manner is also referred to as an ions ring 104.

In some embodiments, the plurality of plants 20 mounted on the circular ring frame 72 may share one power source 30 and one voltage pulse device 40. In use, the voltage pulse device 40 may be configured to transmit the voltage pulse (e.g., up to −60 kV) to any one of the plurality of plants 20, which is shared among the plurality of plants 20 of the ions ring 104. By using the voltage pulse transmission unit 45, inter-plant voltage pulse transmission may be achieved between any two of the plurality of plants 20. Further, plant pots 22 are spaced apart by a suitable distance such that the adjacent plants 22 form physical contacts at the leaf portion to provide an alternative or additional voltage pulse transmission path.

The circular ring frame 72 may be configured in any suitable size to generate a desirable negative air ions profile in the surrounding space. The negative air ions profile of an ions ring 104 with a diameter of 1 meter is illustrated in FIGS. 8A and 8B. The ions ring 104 provides a protective air cleaning area that extends over a substantially large area in the surrounding space. The ions ring 104 is capable of generating negative air ions at an amount about 500 K/cm³ measured at 1 meter away from the exterior surface of the circular ring frame 72, and an amount of about 2 K/cm³ measured at distance of 6 meters from the circular ring frame 72.

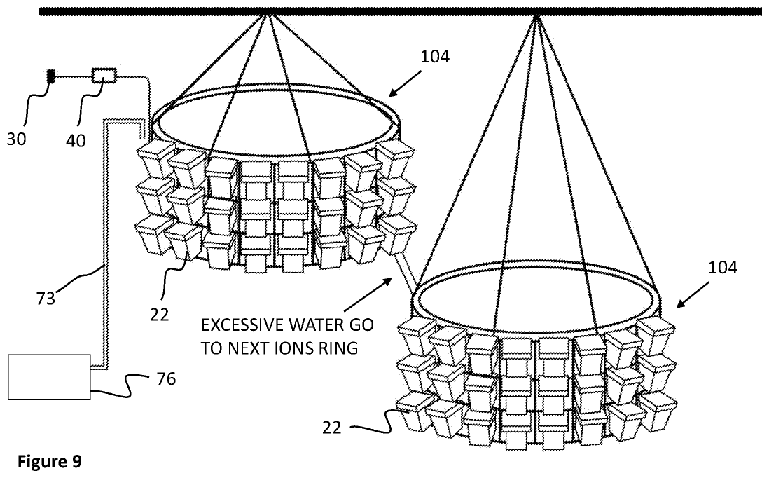

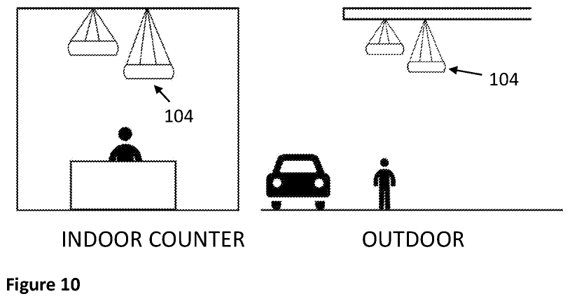

In some embodiments as shown in FIG. 9 and FIG. 10, the ions ring 104 may be mounted on a ceiling surface, and a plurality of suspension cables are configured to hold the ions ring 104 in a suspended position. Multiple ions rings 104 may be provided at different locations and may be hung at different heights, so as to allow a larger area to be cleaned by the negative air ions. The ions ring 104 can be deployed at indoor or outdoor gathering points or along walkways. For example, it can be mounted in indoor bus interchange or car parks to filter the exhaust generated from the stationary buses and protecting the commuters.

It is to be appreciated that similar watering mechanism (as used in the ions panel 103) may be adapted for use in the ions ring 104. In some embodiments, the watering mechanism of the ions ring 104 may be adapted to allow excess irrigation water from a first ions ring 104 to flow to another ions ring 104 (for example, to an ions ring that is below the first one as shown in FIG. 9).

In some embodiments, two or more ions rings 104 may share one power source 30 and one voltage pulse device 40. For example, two ions rings 104 may be electrically connected so that the voltage pulse may be transmitted between the two systems 104.

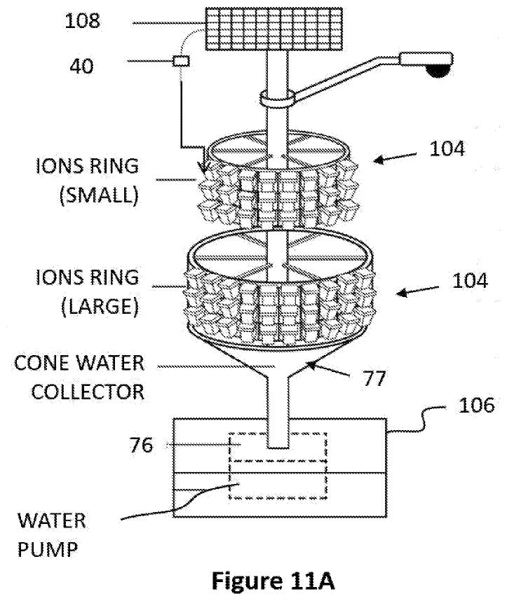

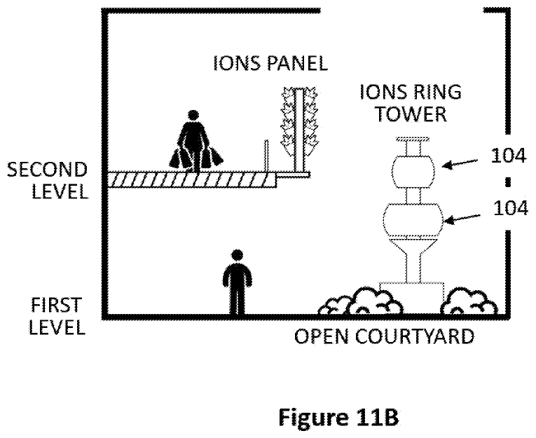

In some embodiments with reference to FIGS. 11A and 11B, two or more ions rings 104 may be mounted onto a pole to form an ions ring tower. The ions ring tower can be deployed on roads with heavy traffic e.g., expressway to curb the PM2.5 pollution from vehicular sources. It can also be placed at gathering points, places with high foot traffic to provide clean and fresh air for the patrons. The standalone nature of the ions ring tower makes it a versatile solution suitable for many sites, both indoor and outdoor. The two or more ions rings 104 mounted on the pole may be of the same size or of different sizes depending on the system requirements. The ions ring 104 located closer to the ground may be configured with a relatively larger size for removing air pollutants produced by the vehicles on the road more efficiently.

In some embodiments, the ions ring tower can be an independent unit with its own power supply from solar panels 108 and its own watering mechanism. In an exemplary ions ring tower of FIGS. 11A and 11B, the water tank 76 with a water pump is disposed within a cemented base 106 of the ions ring tower. The water collector 77 is configured in a cone shape and is disposed at a lower portion of the ions ring tower for collecting the excess irrigation water. The cone shape water collector 77 may be in fluid connection with the water tank 76 so that the excess irrigation water can be recycled and reused. In some embodiments, the ions ring tower formed by the ions ring 104 can also be tethered to the power grid or national water supply.

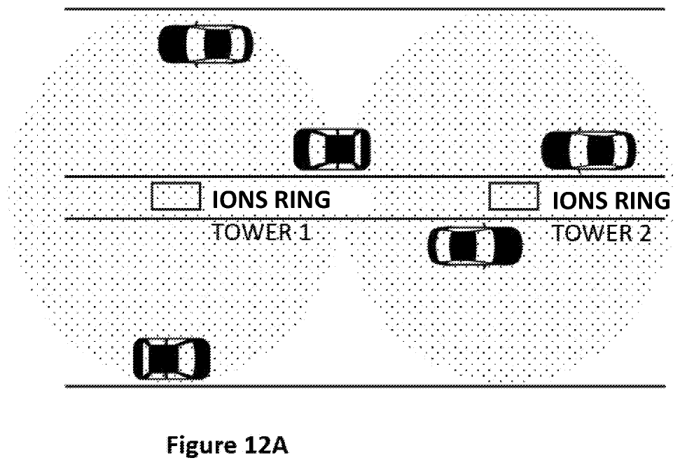

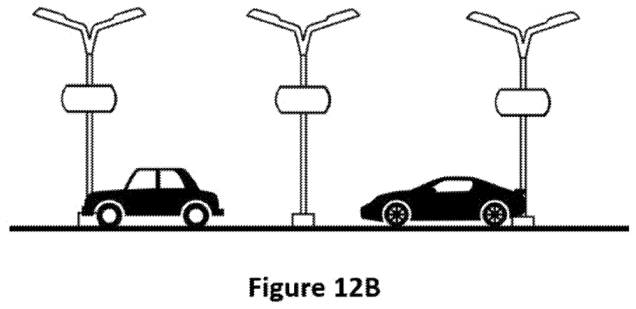

In some embodiments as shown in FIGS. 12A and 12B, the ions ring 104 can be mounted on existing lamp posts to clean air pollutants along the roadside. It can be deployed on lamp posts around the city with minimal disruptions to existing infrastructure. Also, the ions ring 104 can tap into existing power source from the grid, from solar panels on existing lamp posts, or deploy its own solar panel. The water source may be from the existing water supply, collection of rainwater, or from other sources (e.g., the ions ring tower may be part of the flora that is regularly watered).

The system 10 is advantageous in that it is capable of generating high levels of negative air ions in an efficient manner, and at the same time can be deployed with safety, ease and flexibility. Due to the modularity design and ease of deployment, it can be scaled up to provide a substantially large air cleaning area and may be implemented at different locations to cater for both indoor and outdoor air purification applications. Advantageously, the negative air ion generation system 10 provides an efficient, safe, and distributed/localized approach to air purification, in particular, for cleaning particulate air pollutants. Further, the system 10 can be mass-produced at relatively low cost and can be tapped to existing infrastructure with minimal disruption or modification required. It does not require large-scale infrastructure and equipment as used in some existing outdoor air ionization or air filtration systems.

The system 10 of the present disclosure is plant based, where no synthetic air filtration materials (e.g., layers of cleaning filters) are used. Such filtration materials usually have limited and relatively short usage life, as such frequent replacement and regular maintenance are required to achieve a desired filtration efficiency. Negative air ions generated by the system 10 of the present disclosure may effectively accelerate the precipitation of particular matter in the surrounding environment. They may also keep airborne allergens and germs at bay, and neutralize positive ions generated by electronic appliances. The system 10 also brings about other health benefits to human beings. The presence of negative air ions is also credited for providing overall calming effect, relieving stress and drowsiness, boosting energy, and improving alertness. The overall air quality is improved.

It is to be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments unless the embodiment is inoperative without those elements.

It is to be appreciated by the person skilled in the art that variations and combinations of features described above, not being alternatives or substitutes, may be combined to form yet further embodiments falling within the intended scope of the disclosure.

### REFERENCE

10 system
20 plant
20-a plant
20-b plant
20-c plant
20-d plant
22 plant pot
22-a plant pot
22-b plant pot
22-c plant pot
30 power source
36 power supply device
40 voltage pulse device
41 voltage pulse generating circuit
42 output monitoring circuit
44 electronic controller
45 voltage pulse transmission unit
48 conductive terminal
49 metal clamp
50 stimulating probe
63 proximity sensor
70 support structure
71 wall panel
72 circular ring
73 watering channel
76 water tank
77 water collector
79 cavity
81 layer of expanded clay
102 ions hedge
103 ions panel
104 ions ring
106 base
108 solar panel
210 filtration chamber
401 voltage sensing module
402 current sensing module
411 voltage divider
414 filter capacitor
415 inverting operational amplifier
418 non-inverting operational amplifier
419 filter capacitor
500 power on step
501A decision making step: is voltage too high?
501B decision making step: is voltage too high?
502 ramp up output step
503 decision making step: has target voltage been reached?
504 decision making step: is current too high?
505 decision making step: is current too low?
506A power off then delay
506B power off then delay

1. A system for air purification, comprising:
at least a first plant and a second plant, and
a voltage pulse device connectable to a power source for generating and transmitting a voltage pulse to the first plant,
wherein the second plant is connected to the first plant using at least one voltage pulse transmission unit, and the first plant and the second plant are arranged to form one or more contact areas at a leaf portion.

2. The system according to claim 1, wherein the at least one voltage pulse transmission unit is configured to transmit the voltage pulse from a stem portion or a root portion of the first plant to a stent portion or a root portion of the second plant.

3. The system according to claim 1, wherein the voltage pulse device comprises:
a voltage pulse generating circuit configured to receive an input voltage derived from the power source, and to generate the voltage pulse of a desired voltage level,
an output monitoring circuit connected to an output side of the voltage pulse generating circuit, the output monitoring circuit being operable to detect at least one of the following operational parameters: an output voltage level, an output voltage ramping rate, an output current level; and
an electronic controller arranged in data communication with the voltage pulse generating circuit and the output monitoring circuit, the electronic controller being operable to receive at least one of the operational parameters from the output monitoring circuit and to control operation of the voltage pulse generating circuit based on a pre-determined rule.

4. The system according to claim 3, wherein the output monitoring circuit comprises a voltage sensing module connected to a voltage output line of the voltage poise generating circuit, and a current sensing module connected to a ground reference line of the voltage pulse generating circuit.

5. The system according to claim 4, wherein the voltage sensing module connected to the voltage output line comprises a voltage divider, wherein the output voltage is divided by a predetermined number for measurement.

6. The system according to claim 3, wherein the output monitoring circuit being operable to detect the output voltage level, the electronic controller being operable to receive the detected output voltage level, and electronic controller being operable to selectively deactivate the voltage pulse generating circuit based on the detected output voltage level.

7. The system according to claim 3, wherein after the voltage pulse generating circuit is activated and in a transient state before the output voltage teaches the desired voltage level, the output monitoring circuit being operable to detect the output voltage ramping rate, the electric controller being operable to receive the output voltage ramping rate, and the electronic controller being operable to selectively deactivate the voltage pulse generating circuit based on the detected output voltage ramping rate.

8. Use system according to claim 3, wherein in a steady state where the desired voltage level is reached, the output monitoring circuit being operable to detect the output current level, the electronic controller being operable to receive the detected output current level, and the electronic controller being operable to selectively deactivate the voltage pulse generating circuit based on the detected output current level.

9. The system according to claim 1, wherein the voltage pulse device is connectable to a stimulating probe for transmitting the voltage pulse to a root portion of the first plant.

10. The system according to claim 1, further comprising a power supply device for deriving a pre-determined input voltage for the voltage pulse device.

11. The system according to claim 1, further composing a proximity sensing module configured to detect an intruding object.

12. The system according to claim 1, further comprising a support structure for holding the first plant and the second plant in a desired position with respect to each other.

13. The system according to claim 1, further comprising a ventilation mechanism for facilitating air flow in a pre-determination direction and/or at a pre-determined rate.

14. The system according to claim 1, wherein the voltage pulse device comprises:
a voltage pulse generating circuit configured to generate a voltage pulse of a desired voltage level and a desired pulse frequency from an input voltage,
an output monitoring circuit connected to an output side of die voltage, pulse generating circuit, the output monitoring circuit operable to detect at least one of the following operational parameters: an output voltage level, an output voltage ramping rate, an output current level; and
an electronic controller arranged in data communication with the voltage pulse generating circuit and the output monitoring circuit, the electronic controller operable to receive the detected operational parameter and to control operation of the voltage pulse generating circuit based on a pre-determined rule.

15. The system according to claim 14,
wherein the output monitoring circuit comprises a voltage sensing module connected to a voltage output line of the voltage pulse generating circuit, and a current sensing module connected to a ground reference line of the voltage pulse generating circuit; and
wherein the voltage sensing module comprises a voltage divider, wherein the output voltage level is divided by a pre-determined number for measurement.

16. The system according to claim 14, wherein the output monitoring circuit being operable to detect the output voltage level, the electronic controller being operable to receive the detected output voltage level, and the electronic controller being operable to selectively deactivate the voltage pulse generating circuit based on the detected output voltage level.

17. The system according to claim 14, wherein after the voltage poise generating circuit is activated and in a transient state before the output voltage reaches the desired voltage level, the output monitoring circuit being operable to detect the output voltage ramping rate, the electronic controller being operable to receive the detected output voltage ramping rate, and the electronic controller being operable to selectively deactivate the voltage pulse generating circuit based on the detected output voltage ramping rate.

18. The system according to claim 14, wherein in a steady state where the desired voltage level is reached, the output monitoring circuit being operable to detect the output current level, the electric controller being operable to receive the detected output current level, and the electronic controller being operable to selectively deactivate the voltage pulse generating circuit based on the detected output current level.

19. The system according to claim 14, wherein the voltage pulse device comprises a stimulating probe for conducting the voltage pulse to a root portion of the first plant.
